(19) United States
(12) Patent Application Publication
(10) Pub. No.: US 2008/0115010 A1
(43) Pub. Date: May 15, 2008

(54) System and method to establish fine-grained platform control

(76) Inventors: Michael A. Rothman, Puyallup, WA (US); Vincent J. Zimmer, Federal Way, WA (US)

Correspondence Address: INTEL CORPORATION;c/o INTELLEVATE, LLC, P.O. BOX 52050, MINNEAPOLIS, MN, 55402, US

(21) Appl. No.: 11/599,761

(22) Filed: Nov. 15, 2006

(51) Int. Cl. G06F 11/07

(52) U.S. Cl. 714/10

(57) ABSTRACT

In an embodiment, processes are to be migrated in a multi-core computing system. Task migration is performed between and among cores to prevent over tasking or overheating of individual cores. In a platform with multi-core processors, each core is thermally isolated and has individual thermal sensors to indicate overheating. Processes are migrated among cores, and possibly among cores on more than one processor, to efficiently load balance the platform to avoid undue throttling or ultimate shutdown of an overheated processor. Utilization profiles may be used to determine which core(s) are to be used for task migration. Other embodiments are described and claimed.

### CROSS REFERENCE TO RELATED APPLICATIONS

This application is related to U.S. patent application Ser. No. 11/236,404, entitled “PROCESSOR THERMAL MANAGEMENT,” filed on 27 Sep. 2005 by Michael A. Rothman, et al., (attorney docket no. P22480), and assigned to a common assignee.

### FIELD OF THE INVENTION

An embodiment of the present invention relates generally to multi-core computing systems and, more specifically, to task migration between and among cores to prevent overheating, throttling, or shutdown of processors and cores.

### BACKGROUND INFORMATION

In some existing systems, a platform may have multiple sockets and multiple processors. At certain levels of activity, there are situations which may cause the thermal characteristics of the processor to go up (get hotter). There may be thermal sensors built into the processor that can detect when the processor is heating up. Without corrective action, the processor chip could solder itself to the motherboard.

Shutdown or throttling of the processor has been used to solve this problem. In throttling methods, the clock of the processor is reduced so that fewer instructions are executed in a given time period. This will cool down an overheated processor. For instance, a 3 GHz processor may be throttled to 2 GHZ or 700 Mhz. If the throttling is not sufficient to reduce the temperature of the processor, or not available, the processor may be shut down completely to prevent hardware damage.

Often when certain operations or a certain quantity of operations in a given period of time occur on a processor, the processor temperature will increase. Despite most common standard cooling efforts, these thermal fluctuations will occur. If a given heat dissipation starts to exceed a pre-determined value, processors with thermal throttling will start to throttle themselves so that they dissipate less heat. This results in less processing power to maintain a given thermal threshold. (P=V²×F). Further information about thermal sensors and thermal trip registers may be found in Intel® 64 and IA-32 Architectures Software Developer's Manual Volume 3A: System Programming Guide, Part 1 (October 2006) and found on the public Internet ftp site at download*intel*com/design/Pentium4/manuals/25366821.pdf. Note that dots have been replaced with asterisks in the present document to avoid inadvertent hyperlinks.

### BRIEF DESCRIPTION OF THE DRAWINGS

The features and advantages of the present invention will become apparent from the following detailed description of the present invention in which:

FIG. 1 is a block diagram showing an exemplary multi-core processor having four cores (0-3);

FIG. 2 is a block diagram illustrating main flows of an operating system that may migrate processes from one processor to another, according to embodiments of the invention; and

FIG. 3 is a flow diagram of an exemplary method for migrating tasks among cores, according to embodiments of the invention.

### DETAILED DESCRIPTION

An embodiment of the present invention is a system and method relating to task migration of execution between and among cores in a multi-core processor platform to prevent overheating of individual cores. In at least one embodiment, the present invention is intended to individually identify the thermal characteristics of a core or set of cores and migrate the processor tasks to avoid overheating and minimize throttling.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

For purposes of explanation, specific configurations and details are set forth in order to provide a thorough understanding of the present invention. However, it will be apparent to one of ordinary skill in the art that embodiments of the present invention may be practiced without the specific details presented herein. Furthermore, well-known features may be omitted or simplified in order not to obscure the present invention. Various examples may be given throughout this description. These are merely descriptions of specific embodiments of the invention. The scope of the invention is not limited to the examples given.

A single processor may overheat due to its burden rate. This processor may reach a threshold thermal signature, as defined by the manufacturer or system administrator that would require it to be throttled down or shut down in an existing system. It should be noted that an existing common desktop platform may have more than a single core per socket. Future platforms may have many (i.e. 32/64) cores in a given socket. Future multi-core processors, for instance, available from Intel Corp., are expected to have thermal sensors for each core in a multi-core/many-core package. This means that in future deployments of multi/many-core packages, each core will be thermally isolated and can benefit from process migration to facilitate the efficient use of resources without throttling taking place, or at least minimizing throttling. In addition, the concept of “spare cores” is possible due to the vast quantities of processor resources that will be available in future deployments. Processor core tasks may be migrated on or off-line in consideration of such thermal efficiencies. In newer multi-core systems, each core may be thermally isolated, even though the multi-core processor is in a single socket in the motherboard.

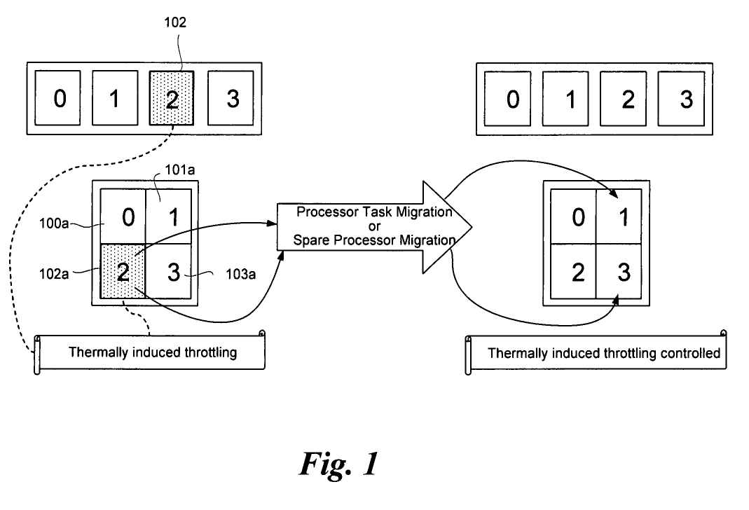

Referring now to FIG. 1, there is shown a block diagram of an exemplary multi-core processor having four cores (0-3). Here it is shown that core 2 (102) is overheating to the point where tasks must be offloaded to other cores. Load balancing may be performed on a work profile basis. However, in existing systems, the entire processor would be throttled down or shut down in reaction to a thermal trip.

In embodiments of the present invention, selected tasks may be migrated from core to core to normalize the thermal characteristics of all of the cores in a single processor. In an exemplary platform, a single multi-core processor may have four cores. The platform may have four multi-core processors. This effectively, gives the platform the processing power of 16 individual, and thermally isolated processing cores. Embodiments of the invention may migrate tasks between and among all of the cores on the platform to reduce thermal output of any given core. Thus, tasks may be migrated across cores, as well as, processor sockets.

It is contemplated that adjacent cores transfer minimal heat between them. However, in future multi-core platforms, it may be possible that adjacent cores will affect their neighbor's heat signature. In this case, an algorithm may be used to assist in choosing an appropriate migration pattern to spread the tasks physically among non-adjacent cores. For instance, referring again to FIG. 1, if the cores are physically configured as a block (100a-d), then core 0 (100a) is physically adjacent to cores 1 (101a) and 2 (102a). Thus, it may be preferred to offload tasks from core 0 (100a) to core 3 (103a). In future deployments with many cores, a 3-dimensional adjacency may be applied. The thermal signatures of cores to which tasks may be offloaded are to be considered as well. For instance, a cooler core will have tasks transferred to it before a core that has already heated up, but below the threshold.

Once it has been determined that migration is necessary, and to which core or processor, one of skill in the art will understand how to migrate tasks between and among cores and processors. A base system processor (BSP) typically has an operating system (OS) resident upon it and can be used to manage other processors/cores. The application processors (AP) are typically the ones requiring migration, based on the work loads of the respective applications. The OS kernel resides on the BSP and the APs are effectively co-processors to the BSP.

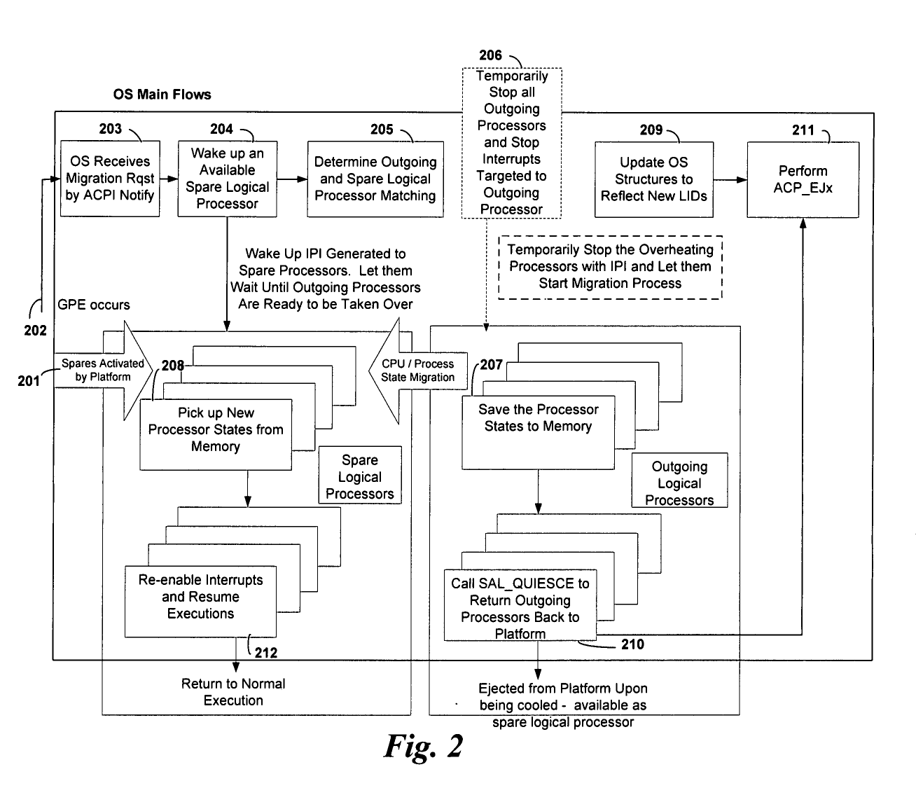

Referring now to FIG. 2, there is shown a block diagram illustrating main flows of an OS that may migrate processes from one processor to another. Spares may be activated by the platform at 201. In other words, a processor or core is awakened or initiated by the platform. A general purpose event (GPE) occurs at 202. The OS then receives a migration request by an ACPI notify command at 203. Spare logical processors, if they exist, may be awakened at 204. Outgoing and spare logical processors are matched based on a predetermined algorithm in 205. The algorithm may use a utilization profile, work load information, proximity information, and/or thermal signature status. At this time, it is determined whether the designated processor or core characteristics are appropriate for a transfer of the task Outgoing processors are temporarily stopped, and interrupts targeted to outgoing processors are temporarily stopped at 206. Processors tasks may then be swapped, and then the outgoing processor is resumed after migrating load-intensive tasks to another core, if possible. Tasks may be transferred from one processor or core, to another. An overheated processor may be shut down, when necessary, or continue at a throttled speed until it has sufficiently cooled. In systems of the prior art, the outgoing processor would be completely stopped and all processes offloaded at 206. However, in embodiments of the present invention, the processor may not necessarily be stopped. Some tasks may be offloaded to another core or processor, but not all.

In systems of the prior art, stopping the processor requires the processor states to be saved to memory in 207 and for the selected processor to pick up the new processor states from memory in 208. Interrupts for the process are enabled in the target processor in 212, and execution is resumed. The OS updates its structures to reflect the new logical IDs (LIDs) in 209. The outgoing processor would then be returned to the platform in 210. Once the processor or core is sufficiently cooled and returned to the platform, it is available for use as a spare and may have tasks migrated to in response to further thermal events.

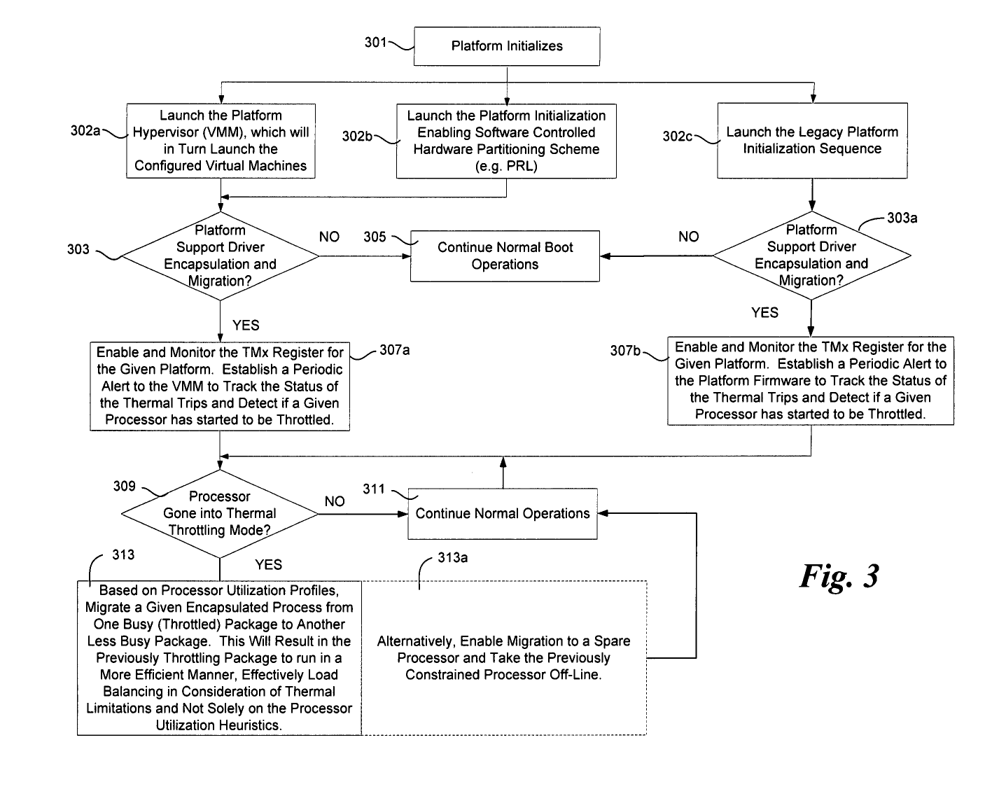

Embodiments of present invention use similar techniques for migrating tasks and processes among cores and processors, but vary in several ways. One difference, as highlighted above is that the outgoing processor is not typically stopped longer than necessary to offload one or more tasks. Further details of this migration are discussed in conjunction with FIG. 3.

Referring now to FIG. 3, there is shown a flow diagram of an exemplary method for migrating tasks among cores, according to embodiments of the invention. The platform initializes in block 301. Three alternative embodiments are discussed with respect to 302a-c. Embodiments of the invention may be implemented using virtualization technology (302a), embedded platform technology (platform resource layers PRL) (302b), and legacy platforms (302c). Each will be discussed in turn.

In a virtualized environment running a virtual machine monitor (VMM), a hypervisor or VMM is launched in 302a. The VMM launches configured virtual machines to control thermal monitoring and the migration of tasks among cores. In an embedded platform architecture, the embedded platform may run in a privileged layer on the platform. The embedded platform initializes, enabling software controlled hardware partitioning, in block 302b. In a legacy platform, an initialization sequence is performed in block 302c.

Regardless of the architecture of the platform, a determination may be made as to whether the platform supports driver encapsulation and migration, in block 303a and 303c. If not, normal boot operations are continued in block 305.

In a virtualization or embedded platform architecture, the thermal registers are enabled and monitored in block 307a. A periodic alert is established to alert the VMM or embedded platform of impending thermal issues. The status of the thermal trips are tracked and throttled processors are detected.

In a legacy system, the thermal registers are enabled and monitored in block 307c. A periodic alert is established for the platform firmware (BIOS or EFI) to track the status of the thermal trips and detect if a given processor has been throttled.

A determination is made in block 309 as to whether the processor has gone into thermal throttling mode, i.e., a thermal alert is triggered. If not, normal operations are continued in block 311. Otherwise, based on processor utilization profiles, a given encapsulated process is migrated from one busy (throttled) package to another less busy package, in block 313. This results in the previously throttling package to run in a more efficient manner, effectively load balancing in consideration of thermal limitations and not solely on the processor utilization heuristics. Alternatively, migration to a spare processor or core is enabled in block 313a. The previously constrained processor may be taken off line.

Utilization profiles may be based on core proximity (how far they exist physically from the throttling processor). Further, the thermal sensors for each individual core may be read separately to determine which processor has the coolest operating temperature overall. Based on the profiling rules, it may be determined that the target core is to be located on a processor where only 50% or fewer cores are operating at threshold temperatures. In other profiles, it may be determined that the migrated processes should be executed on cores of the same processor. Characteristics of the individual multi-core processors on a multi-processor platform may be used to identify proximity, or compatibility issues and be applied to the rules.

In systems of the prior art, throttling automatically occurs when a processor reaches a thermal threshold and all processes are offloaded to another processor at another thermal threshold. This method can cause processes to be continually passed back and forth between processors when the application puts a heavy load on the processor. Embodiments of the present invention enable load balancing among the processors and cores to avoid completely shutting down a processor or thrashing the processes between processors.

In addition, in existing multi-core systems, there is no way to take advantage of a core's isolated thermal signature. If one core in a processor reached a thermal threshold, the processor's thermal sensor was triggered and all processes were offloaded to another processor and the triggered processor was shut down. Embodiments of the present invention allow selected processes to be offloaded between and among both cores on the same multi-core processor and cores on other multi-core processors. Further, as the number of cores on a processor increase, spare cores will be available for migration and load balancing to efficiently execute heavy load applications without requiring an entire processor to throttle down to a reduced clock speed or being forced to shutdown altogether.

In some embodiments, the thermal trigger will cause the processor to throttle down temporarily while processes are being offloaded to other cores. Once the processes are migrated, the outgoing processor may resume normal clock speed (un-throttled). Whether the processor throttles during the migration process is driven by the thermal sensor and triggering threshold.

Existing systems do not currently perform thermal-based load balancing between processors. Further, existing multi-core systems do not take advantage of thermally isolated cores to efficiently balance processing loads. Currently, when a processor's thermal sensor is triggered, the processor must throttle down to a reduced clock speed or all processes of the affected processor must be migrated to another single processor. Embodiments of the invention take advantage of the fact that the individual processes do not typically require processing on a specific core, and multi-processors do not often require processing on the same core. The operating system, firmware, VMM or embedded platform may move the processes to any compatible core. Those of skill in the art are aware of various techniques that may be used to effect a process migration to another core or processor, because process migration must occur when a processor is shutdown, today. The choice of where to migrate the process (core or processor), and which processes to migrate may be efficiently performed through the work load and utilization profiles and rules, as discussed above, according to embodiments of the present invention.

Referring again to FIG. 3, blocks 302a-c outline differences in embodiments based on platform architecture. In a virtualization platform (302a), an agent may reside within the context of the VMM. This agent will exhibit similar behavior to an agent, or partition, within a partitioned environment (302b). However, the partitioned environment will not have a VMM, per se. The embedded partition, or system partition, will monitor system operations. The thermal sensors/activities will be monitored from within the partitions, with assistance from the chipset. The chipset maintains isolation between partitions.

In a legacy system, the triggers will reside in the system management mode (SMM) regardless of whether the platform is in the Itanium Processor Family (IPF or XPF), IA-32 or other architecture. The SMM, or firmware code, has thermal management monitors registered to act upon receiving a thermal alert. In this case, the SMM will trigger a system management interrupt (SMI). The appropriate interrupt service routine (ISR) handles the actual migration from one core or processor to another, relying on the utilization profiles. ACPI notification may assist legacy migration. FIG. 1 shows an embodiment of the present invention implemented on a legacy architecture, as discussed above.

The techniques described herein are not limited to any particular hardware or software configuration; they may find applicability in any computing, consumer electronics, or processing environment. The techniques may be implemented in hardware, software, or a combination of the two.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks or portions thereof may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A system comprising:
a platform having at least one multi-core processor, each core being thermally isolated and having a corresponding thermal sensor; and
an agent to determine whether a thermal sensor for a first core indicates a level above a predetermined threshold, and if so, the agent to migrate one or more processes from the first core to one or more other cores in the platform, and if not, then the agent to allow processing to continue.

2. The system as recited in claim 1, wherein the agent is to use a utilization profile to determine which of the one or more other cores to which to migrate the one or more processes.

3. The system as recited in claim 2, wherein the utilization profile comprises thermal proximity information corresponding to the at least one multi-core processor.

4. The system as recited in claim 2, wherein the utilization profile comprises rules used by the agent to load balance processes of the cores to reduce migration thrashing and processor throttling.

5. The system as recited in claim 1, wherein the agent resides in one of a virtual machine monitor in a virtualization platform, embedded platform in a chipset partitioned system, or system management mode in a legacy system.

6. The system as recited in claim 1, further comprising an alert component to track the status of thermal trips corresponding to cores in the at least one multi-core processor.

7. The system as recited in claim 1, wherein the migration of a process is to one of a same multi-core processor or a different multi-core processor than the first core.

8. The system as recited in claim 1, wherein the migration of a process is to one of a core less busy than the first core or to a spare core having no active processes.

9. A method comprising:
launching a core load balancing agent;
enabling thermal sensor monitors, each thermal sensor corresponding to one of a plurality of thermally isolated cores in a multi-core processor on a platform;
monitoring the thermal sensors;
alerting the agent with a status for each thermal sensor;
triggering a load balance operation based on a thermal sensor status of a first core; and
balancing processing load among the plurality of cores.

10. The method as recited in claim 9, wherein balancing further comprises:
accessing a utilization profile comprising work load information corresponding to each of the plurality of cores in the platform;
determining an efficient balance of processes among the plurality of cores; and
migrating selected processes from the first core to one or more cores in the platform.

11. The method as recited in claim 10, wherein the utilization profile further comprises thermal proximity information corresponding to cores in the platform.

12. The method as recited in claim 10, wherein the utilization profile further comprises rules used by the agent to load balance processes of the cores to reduce migration thrashing and processor throttling.

13. The method as recited in claim 9, wherein the agent resides in one of a virtual machine monitor in a virtualization platform, embedded platform in a chipset partitioned platform, or system management mode in a legacy platform.

14. The method as recited in claim 9, wherein the balancing comprises migrating at least one process from the first core one of a same multi-core processor or a different multi-core processor than the first core.

15. The method as recited in claim 14, wherein the migration of a process is to one of a core less busy than the first core or to a spare core having no active processes.

16. A machine readable storage medium having instructions stored therein that when executed case a machine to:
launch a core load balancing agent;
enable thermal sensor monitors, each thermal sensor corresponding to one of a plurality of thermally isolated cores in a multi-core processor on the machine;
monitor the thermal sensors;
alert the agent with a status for each thermal sensor;
trigger a load balance operation based on a thermal sensor status of a first core; and
balance processing load among the plurality of cores.

17. The medium as recited in claim 16, wherein balancing further comprises instructions to:
access a utilization profile comprising work load information corresponding to each of the plurality of cores in the machine;
determine an efficient balance of processes among the plurality of cores; and
migrate selected processes from the first core to one or more cores in the machine.

18. The medium as recited in claim 17, wherein the utilization profile further comprises thermal proximity information corresponding to cores in the machine.

19. The medium as recited in claim 17, wherein the utilization profile further comprises rules used by the agent to load balance processes of the cores to reduce migration thrashing and processor throttling.

20. The medium as recited in claim 16, wherein the agent is to reside in one of a virtual machine monitor in a virtualization platform, embedded platform in a chipset partitioned platform, or system management mode in a legacy platform.

21. The medium as recited in claim 16, wherein the balancing comprises instructions to migrate at least one process from the first core one of a same multi-core processor or a different multi-core processor than the first core.

22. The medium as recited in claim 21, wherein the migration of a process is to one of a core less busy than the first core or to a spare core having no active processes.
